(19) United States
(12) Patent Application Publication
(10) Pub. No.: US 2005/0109294 A1
(43) Pub. Date: May 26, 2005

(54) Rotary cylinder fluid pressure machine

(76) Inventors: Anthony Leonardus Wondergem, Queensland (AU); Anthony John Higham, Auckland (NZ)

Correspondence Address: LAW OFFICES OF JACOBSON HOLMAN;PROFESSIONAL LIMITED LIABILITY COMPANY, 400 SEVENTH STREET, N. W., WASHINGTON, DC, 20004, US

(21) Appl. No.: 10/937,302

(22) Filed: Sep. 10, 2004

Related U.S. Application Data
(63) Continuation of application No. PCT/NZ01/00090, filed on May 15, 2001.

(30) Foreign Application Priority Data
May 15, 2000 (NZ) 504574

(51) Int. Cl. F02B 57/00

(52) U.S. Cl. 123/44 R

(57) ABSTRACT

A rotary cylinder fluid pressure machine such as an internal combustion engine (10) has a cylindrical stator (11) within which there is rotatable a rotor (12) from which project five cylinders (13, 14, 15, 16, 17). The cylinders (13, 14, 15, 16, 17) are equi-angularly spaced about the rotational axis of the rotor (12) and are equally spaced along the said axis. In each cylinder (13, 14, 15, 16, 17) is a respective piston (18, 19, 20, 21) connected by a respective connecting rod (23, 24, 25, 26 27) to respective crank pins of a crank shaft (33) which is coaxial with the rotor (12). The five throws of the crank shaft (33) bearing the respective crank pins have the same equi-angular separation as the cylinders (13, 14, 15, 16, 17). The rotor (12) and crank shaft (33) are interconnected by bevel gears (not shown) whereby rotation of one will cause counter-rotation of the other at the same speed. This allows the spark plugs (39) to be aligned in a first radial plane which is angularly offset from a second radial plane containing the inlet ports (34).

### FIELD OF THE INVENTION

This invention relates to a radial fluid pressure machine such as a motor or pump, and more specifically, although not exclusively, to an improvement in the kind of radial internal combustion engine disclosed in International Patent Application Serial No. WO 99/24696 to which reference is made for a better understanding of the present invention.

In the Specification of that International Patent Application there is a description of internal combustion engines having one or more than one cylinder in which a respective piston is reciprocable. For most practical applications an engine will have at least three, and preferably five cylinders equi-angularly spaced about the axis of the crank shaft to which the pistons are connected.

The engine disclosed in International Patent Application Serial No. WO 99/24696 has many advantages such as its light weight and compact design and high power to weight ratio. In particular, because the rotor carrying the pistons rotates counter to the crank shaft but at the same speed no flywheel is required and there is no torque reaction in the engine, which makes it particularly suitable for use in aircraft and helicopters.

### OBJECTS OF THE INVENTION

An object of the present invention is to improve upon the engine of International Patent Application Serial No. WO 99/24696 and specifically to provide a rotary internal combustion engine improved in that it has improved stability, the cylinders can be more widely spaced axially of the crank shaft and in that inlet and exhaust ports can be shared between cylinders instead of requiring that respective inlet and exhaust ports are dedicated to respective cylinders.

### SUMMARY OF THE INVENTION

In accordance with the present invention there is provided a rotary fluid pressure machine of the kind in which a plurality of cylinders are provided equi-angularly spaced about the rotational axis of a rotor which is coaxial with a crank shaft to which pistons reciprocable in the respective cylinders are connected, the crank shaft and rotor being interconnected such that they will counter rotate at the same speed, characterised in that the crank shaft has a number of throws corresponding with the number of cylinders and having the same angular relationship, each piston being connected to a respective crank pin of a respective said throw, and in that inlet and exhaust ports for all of the cylinders lie in the same segments of a stator in which the rotor is rotatable.

Preferably the machine is a rotary internal combustion engine with inlet manifolds whereby a fuel and air mixture may enter each cylinder lie in a same first radial plane of the stator. Compression and ignition of the mixture in each cylinder preferably also occurs in a same second radial plane of the stator, this latter being the plane in which all spark plugs respectively associated with the cylinders will lie when the engine is other than a diesel engine.

### BRIEF DESCRIPTION OF THE DRAWINGS

A preferred embodiment of the present invention will now be described by way of non-limitative example with reference to the accompanying drawings, in which:

FIG. 1 is a perspective view of an internal combustion engine in accordance with the invention;

FIG. 2 is an end elevation of the engine of FIG. 1 with parts removed;

FIG. 3 is a sectional view taken generally on the line III-III of FIG. 2;

FIG. 4 illustrates the crank shaft of the engine of FIGS. 1-3;

FIG. 5 is a schematic view;

FIG. 6 shows the rotor and crankshaft; and

FIG. 7 shows a perspective of a floating seal.

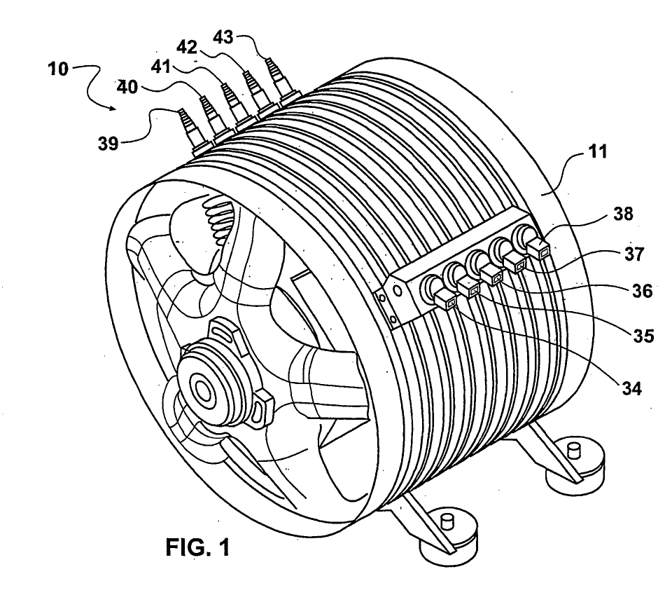

### DESCRIPTION OF PREFERRED EMBODIMENT

### EXAMPLE 1

The rotary internal combustion engine 10 illustrated comprises a cylindrical stator 11 within which there is rotatable a rotor 12 from which project five cylinders 13, 14, 15, 16 and 17. The cylinders are equi-angularly spaced about the rotational axis of the rotor 12 and are equally spaced along the said axis. In each cylinder is a respective piston 18, 19, 20, 21 and 22 connected by a respective connecting rod 23, 24, 25, 26 and 27 to respective crank pins 28, 29, 30, 31 and 32 of a crank shaft 33 which is coaxial with the rotor 12. The five throws of the crank shaft 33 bearing the respective crank pins 28-32 have the same equal angular separation as the cylinders 13-17. The rotor 12 and crank shaft 33 are interconnected by bevel gears (not shown) whereby rotation of one will cause counter-rotation of the other at the same speed.

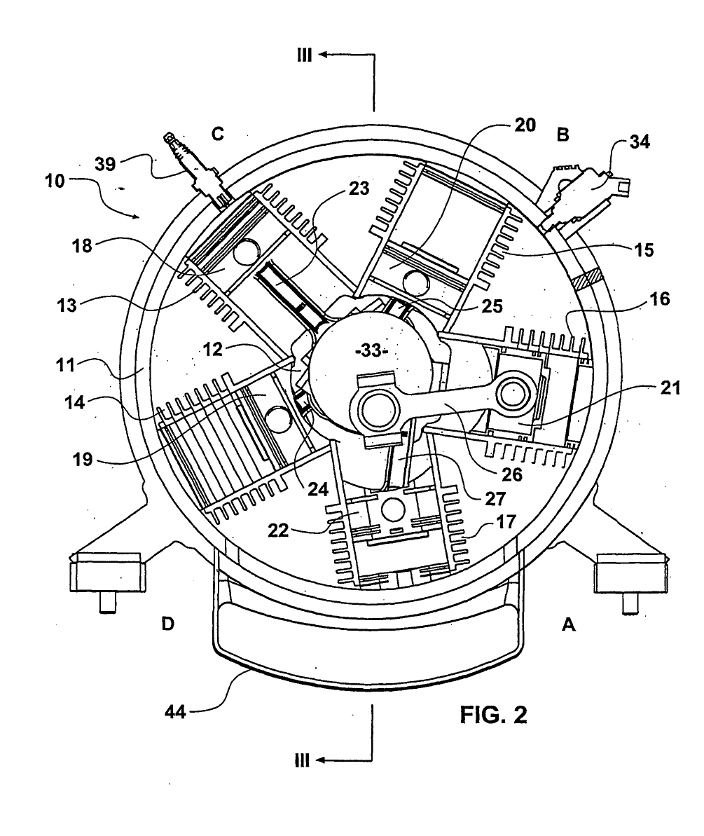

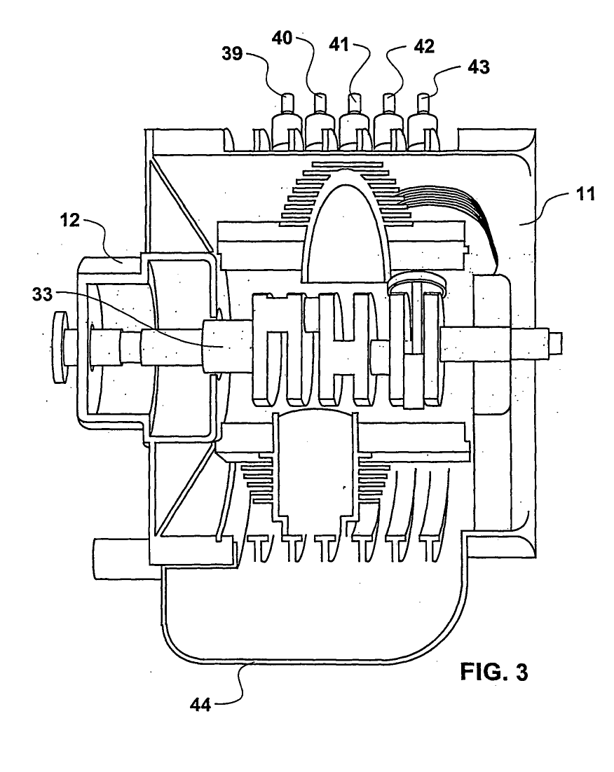

The stator 11 is penetrated by five fuel inlet manifolds 34, 35, 36, 37 and 38 all lying in the same first plane radial with respect to the stator and by five spark plugs 39, 40, 41, 42 and 43, again all lying in the same second radial plane of the stator which is displaced approximately 35 degrees from the plane of the manifolds. There is an exhaust manifold 44 under the stator 11 into which exhaust slots (not shown) in the region D-A (FIG. 2) open and there are air intake slots (not shown) in the region A-B of the stator.

As described in the Specification of International Patent Application Serial No. WO 99/24696 there is associated with each cylinder 13-17 respective piston ring means (not shown) forming a seal against the internal wall of the stator 11.

The operation of the engine 10 will now be described. As viewed in FIG. 2 the rotor 12 is rotating anti-clockwise while the crank shaft 33 is rotating clockwise at the same speed. As a cylinder such as 16 moves through the segment A-B of the stator 11 its piston 21 is descending and air and then fuel are drawn in. As a piston such as 15 moves through the segment B-C of the stator its piston 20 ascends, thereby compressing the fuel and air mixture in the cylinder. At C where a cylinder such as 13 aligns with the associated spark plug 39 the associated piston 18 is at top dead centre when the compressed mixture is ignited by the spark plug, causing the piston 18 to perform a power stroke as the cylinder moves through the segment C-D. Finally a cylinder such as 17 aligns with the associated exhaust port(s) in segment D-A and then the sequence recommences.

### EXAMPLE 2

The following is a description of a prototype engine constructed in accordance with the teachings of Example 1.

Overview

The prototype engine can be considered in terms of three main components.
1. Stator. This is the engine housing or outer casing that provides the porting and support for the injection system and spark plugs; the inner surface of this housing is the area that supports combustion.
2. Rotor. The rotor rotates within the stator and consists of a central core that houses the crankshaft and supports the five cylinders in a radial fashion. These cylinders are separated lineally by 25 mm each giving a short crankshaft and 25 mm of bore separation on a lineal plane.
3. Crankshaft. This differs from conventional crankshafts in that it is lighter in construction, and each crank pin is offset 72 degrees in this 5-cylinder configuration and does not have an opposite number as in most conventional units.
   The Basic Principle

The rotor is mounted with bearings inside the stator and is free to turn in a radial fashion within that part. The crankshaft is mounted with bearings inside the rotor and is free to turn in a radial fashion within that part.

With specially designed timing gears adapted to the unit linking all three components together and with the stator being mounted in a fixed position, the gearbox will only allow the crankshaft to rotate in one direction provided the rotor rotates in the opposite direction the exact same number of degrees as the crankshaft.

Rotating the crankshaft through 360 degrees causes the rotor to travel the same distance in the opposite direction this effectively causes the pistons to travel up and down the cylinders twice giving a four-stroke cycle for each piston every single revolution of the engine.

Specifics

The following is a description of the engine 21 concepts covering most aspects of its development to date.

Areas considered.
Stator
Rotor
Crankshaft
Electronics
Ignition
Pistons
Cylinders
Timing gears
Fuel system
Inlet system
Exhaust system
Cooling
Lubrication

Combustion sealing device.

TECHNICAL DATA FOR PROTOTYPE

| | |
|---|---|
| Engine type | four stroke radial |
| Fuel | 96 octane petrol |
| Number of cylinders | 5 |
| Number of firings per revolution | 5 |
| Bore | 62 mm |
| Stroke | 53 mm |
| Cubic capacity | 800 cc |
| Weight | approx. 47 kg |
| Length | 350 mm |
| Height | 340 mm |
| Electronics | yes |
| Fuel injection | yes |
| Special materials | molybdenum, ceramics |

Stator
General

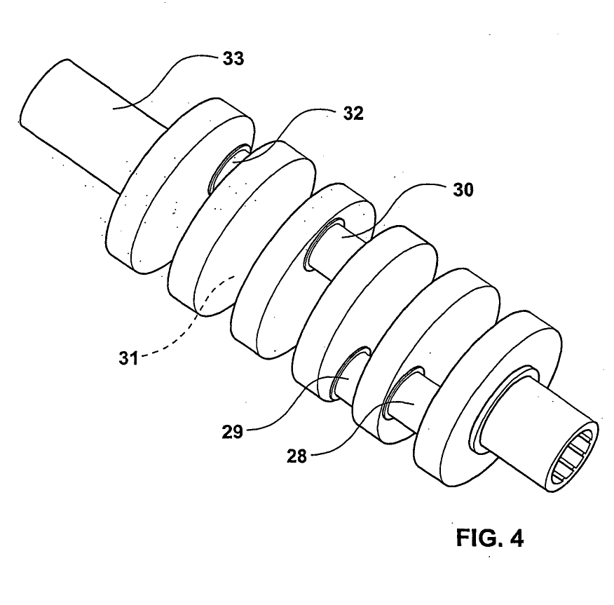

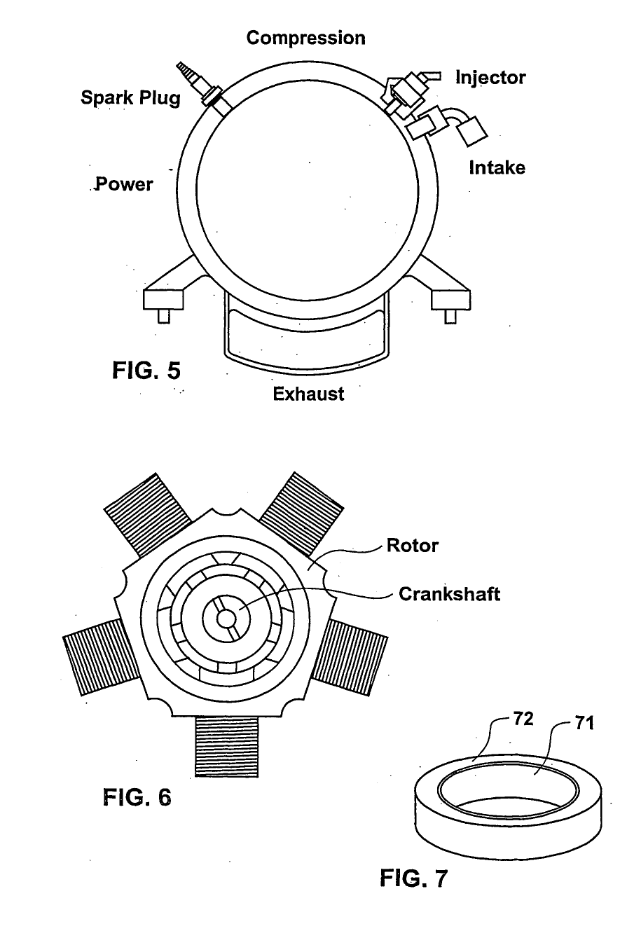

The stator when viewed front on gives an insight into the firing cycle of the prototype engine as show in FIG. 5. The rotor revolves in an anticlockwise direction inside the stator as viewed in FIG. 5.

Configuration

As can be seen from the schematic of FIG. 5, the firing cycle in the stator is completed in 360 degrees and not 720 degrees as in conventional four stroke engines.

Materials

The present materials used in construction of the prototype stator is cast iron, although this could and would be changed in a production engine to aluminium with a hard chromed cast iron or steel sleeve inserted to facilitate a combustion surface.

Manufacturing Note

Casting this housing would be a better alternative to machining one as many units could be made from the one mould.

Rotor

The rotor is manufactured from aluminium and has the five cylinders (in this instance) mounted to its exterior, an end plate is fitted both ends to facilitate the mounting of the crankshaft and to mount bearings to allow the rotor to be mounted in the stator.

In this instance the rotor revolves in an anti-clockwise in the stator while the crankshaft rotates clockwise.

The cylinders are arranged in a firing order of 12543; this facilitates the sequential firing of all cylinders in 360 degrees of rotation.

Other configurations need to be considered as this may allow simpler balancing of this unit.

The crankshaft is supported by bearings at each end and has no centre hanger bearing in this instance.

A small amount of oil is retained in this unit by extending the cylinders down into the rotor.

Crankshaft

The crankshaft shown in FIG. 4 differs from a conventional crankshaft as it can be much lighter in construction and with no provision for any centre main bearings. This particular crankshaft was manufactured from a single billet of EN39B steel with a Rockwell hardness of 60. The output shaft was made separately from the crankshaft and adapted to the crankshaft with a spark-eroded spline. The crankshaft was stress relieved then case hardened and ground to suit the big end roller bearings. The crankshaft output shaft was constructed in much the same manner as the crankshaft and was made as a separate part to facilitate adaption to the timing gear assembly.

Electronics

Experiments have been conducted with various electronic control software for internal combustion engines. We have found that an Australian company called MOTEC was chosen due to the flexibility of its package in allowing us to program the functions in a manner we required.

The prototype engine for example can run satisfactorily with the ignition timing at minus 20 degrees to plus twenty five degrees at idle speeds of around 2000 rpm.

Other facets of the software allow flexibility in the areas of engine manifold pressure compensation, engine temperature compensation, inlet air temperature compensation, atmospheric air pressure and engine rpm compensation plus others.

Throughout the programming of the electronics it has been necessary-to constantly change the settings as improvements are made in other areas of the engine such as combustion chamber design etc.

The facilities exist in this MOTEC software to allow the fitting of knock and Lambda sensors that will be required as development continues.

Ignition

To prevent any combustion leakage from the combustion-sealing device it was necessary to have an access hole for the production of a spark no larger than the width of the seal section. To achieve this a modification to a conventional spark plus was needed, the earthing electrode of the spark plug was removed and the thread was machined back to expose more of the centre electrode.

When in position in the engine the centre electrode of the spark plug protrudes through the stator to within 0.5 mm of the combustion surface. This gives an effective spark for combustion without compromising the integrity of the floating seal.

The Motec electronics are given a maximum of 40 degrees advance within the parameters of the window of opportunity afforded by the aperture in the seal.

Pistons

The pistons in the present prototype were designed specifically for this engine. The crown of the piston was raised to increase the compression ratio and was to be machined later to better facilitate combustion but as yet this has not been actioned. The piston skirt has been modified to give clearance to the crankshaft and conrod big ends. There are two compression rings above the gudgeon pin and an oil ring below the gudgeon pin with the second compression ring acting as an oil scraper. The compression height of the piston was kept to a minimum to assist in attaining a minimal engine diameter. The piston has a standard gudgeon pin with roller bearings in the little end and is lubricated by oil splash fed to the rollers.

Cylinders

The present engine cylinders are made entirely of spun cast iron and have air-cooling fins machined into the stock material.

In this example there is no special provision made to accommodate the floating seal, as the seal is adapted to the inside of the cylinder.

The cylinders are all identical wit the exception of that area adjacent to the crankshaft where each cylinder has been relieved to give clearance to the crankshaft.

The cylinders are all bolted to the rotor in a radial fashion and balanced with that unit.

It is envisaged that these cylinders would be cast in aluminium in the future and then fitted with a cast iron sleeve.

Timing Gears

The timing gear arrangement on the prototype engine is the trick that allows this concept to come together. The responsibility of the gears is to force the three main components (stator, rotor and crankshaft) to form a relationship.

With the stator fixed and the gear system attached, the rotor and crankshaft are compelled to move rotationally in opposite direction to each other by exactly the same number of degrees and in sync with stator. This characteristic allows the crankshaft to carry on in a normal fashion while at the same time the rotor allows the cylinders to access the appropriate facility required for a four stroke cycle.

The gear ratio used in the prototype engine is 1 to 1 causing both the rotor and the crankshaft to rotate at the same rate.

Fuel System

Because of the unusual requirements of the prototype engine a complete fuel system had to be developed. This was achieved by incorporating the five injectors at 25 mm intervals in a fuel rail that was cooled by the fuel as it circulated through the system.

The injectors used for this purpose are only used to approximately one third of their capacity and are not capable of running the low delivery rates required for good mixtures at slow idle speeds of around 200 rpm.

A conventional BMW fuel pump running at 40 psi is used to deliver the fuel through a recirculatory system.

Inlet System

The inlet system on the prototype petrol version of the concept incorporates a number of check valves; these valves are made of nylon and function only to prevent a backward flow of air in the inlet manifold.

The present prototype engine has only enough of an inlet facility to allow approximately 1600 rpm. An extension of this system would allow engine speeds of around 3500 rpm.

The 3500-rpm restriction to the maximum revolutions comes from the window of opportunity in the floating seal and not the ability to receive air. This problem can be overcome by the introduction of a secondary injector thus allowing speeds of 6000 rpm or more.

Exhaust System

The present exhaust system incorporated in the prototype engine is only designed to the facility to extraction of the exhaust gases and will need further development in the future.

Tests have shown that it may be necessary to create an extraction system in the exhaust to stop a build-up of gases in the stator and prevent burnt gases being recirculated. A positive pressure in the stator using a fan could alleviate any build-up of gases and provide cooling at the same time.

Cooling

Cooling is presently provided by air being induced into the stator by the exhaust system and is adequate for the present in a no load situation. It is envisaged that a fan will be required when tests under load are undertaken and this has been designed and will be fitted in the near future.

The cylinders are air cooled and as such are fumed, calculations for these fins will be required as will the finite element testing to determine the correct ratio of these fins.

Lubrication

Lubrication of the crankshaft and gudgeon bearings has been simplified by the use of needle rollers. A small quantity of oil is introduced to the engine and relies on centrifugal force to deliver a small volume to the thrust side of the piston.

The needle rollers operate satisfactorily in the oily atmosphere created by the disturbed interior mechanical actions of the cylinders, conrods and crankshaft etc. The provision of a full pressure system is envisaged for any future development.

Combustion Sealing Device

A floating seal 70 (combustion sealing device) is used with each cylinder, not only for sealing the combustion and maintaining compression, as well as being capable of supporting a vacuum; it forms a part of the combustion chamber. It preferably has an internal ceramic coating 71 and a wear resistant coating 72 on its outermost (curved) face. We have found that a molybdenum coating 72 has performed satisfactorily in the prototype engine.

Observations

Many aspects of the prototype engine differ from convention reciprocating 4-stroke engines, and the ability of this design to allow for porting of the exhaust as opposed to valves is one of them.

By allowing the exhaust gases to be virtually dumped to atmosphere through the large opening in the floating seal and ports the need for an early opening of an exhaust valve is delayed keeping pressure on the piston longer.

The injection of fuel is unique as fuel can be injected directly into the cylinder at any stage of the intake stroke with little modification to existing injection systems.

Very little exist in area of gaskets and seals including a cylinder head, as the concept provides for creating combustion against the inner surface of the stator there is no requirement for head gaskets.

The timing gears are unique in so far as they were created from two different technologies and combined to attain the desired effect. It was necessary for the gearing system to be anchored to the stator and only allow the rotor and crankshaft to operate simultaneously in the opposite directions at the same time.

The speeds at which the rotor turns limits the amount of time the cylinders are available for the injection of fuel and the time available for the chemical reaction required to create combustion this is what we call the “window of opportunity”.

The “floating seal” is the device that keeps this concept simple in that it provides the sealing forces necessary to create a seal between the rotating cylinders and the stationary stator.

This seal design is capable of coping with the pressure forces during compression and combustion as well as providing excellent performance in the area of vacuum requirements.

Advantages

Because the pistons 18-22 are connected to respective crank pins 28-32 and not all to the same crank pin the overall length of the engine is not critical and the engine will function in a more balanced manner. All intake manifolds can be arranged in the same plane and all spark plugs can be arranged in the same plane. Air inlet and exhaust ports can be shared between adjacent cylinders enabling them to be of greater dimensions than if each cylinder must have its own dedicated inlet and outlet ports. With the arrangement of the present invention there is a greater throughput of air, resulting in more efficient cooling so that fan cooling may be dispensed with at least in some applications.

Variations

The examples herein disclosed show a four stroke engine using spark plugs but it will be evident that a two stroke or a diesel engine could be made to work on the same principles, or the same basic construction can be used as a compressor. The use of five cylinders is merely exemplary. More or less than five cylinders may be employed.

1. A rotary fluid pressure machine of the kind in which a plurality of cylinders are provided equi-angularly spaced about the rotational axis of a rotor which is coaxial with a crank shaft to which pistons reciprocable in the respective cylinders are connected, the crank shaft and rotor being interconnected such that they will counter rotate at the same speed, characterised in that the cylinders are spaced longitudinally along the rotational axis and the crank shaft has a number of throws corresponding with the number of cylinders and having the same angular relationship, each piston being connected to a respective crank pin of a respective said throw, and in that inlet and exhaust ports for all of the cylinders lie in the same segments of a stator in which the rotor is rotatable.

2. A rotary fluid pressure machine as claimed in claim 1, wherein the longitudinal spacing of cylinders allows more than one cylinder to share an inlet port.

3. A rotary fluid pressure machine as claimed in claim 1, wherein the machine is a compressor.

4. A rotary fluid pressure machine as claimed in claim 1, wherein the machine is a rotary internal combustion engine and inlet manifolds whereby a fuel and air mixture may enter each cylinder lie in a first radial plane of the stator.

5. A rotary fluid pressure machine as claimed in claim 4, wherein ignition of the mixture in each cylinder occurs in a second radial plane of the stator, this latter being the plane in which all spark plugs respectively associated with the cylinders will lie when the engine is other than a diesel engine.
